(19) United States
(12) Patent Application Publication
(10) Pub. No.: US 2026/0328475 A1
(43) Pub. Date: Oct. 22, 2026

(54) SYSTEMS AND METHODS FOR REMOVING AQUEOUS LIQUIDS FROM A SOLID POROUS MATERIAL VIA SOLVENT DISPLACEMENT

(71) Applicant: BATTELLE ENERGY ALLIANCE, LLC, Idaho Falls, ID (US)

(72) Inventors: Caleb C. Stetson, Idaho Falls, ID (US); Hyeonseok Lee, Ammon, ID (US); Christopher J. Orme, Firth, ID (US); Rebecca M. Brown, Idaho Falls, ID (US); Jaya Shankar Tumuluru, Idaho Falls, ID (US); Vicki S. Thompson, Idaho Falls, ID (US); Lynn M. Wendt, Idaho Falls, ID (US); Christopher L. Williams, Idaho Falls, ID (US); Aaron D. Wilson, Idaho Falls, ID (US)

(21) Appl. No.: 19/119,368

(22) PCT Filed: Oct. 12, 2023
(86) PCT No.: PCT/US2023/076652

§ 371 Date: Apr. 8, 2025

(51) Int. Cl. F26B 5/00

(52) U.S. Cl. CPC F26B 5/005

(57) ABSTRACT

A method for removing an aqueous liquid from a liquid-entrained porous solid material includes contacting the liquid-entrained porous solid material with a polar organic liquid, the liquid-entrained porous solid material containing the aqueous liquid in pores thereof. The method also includes displacing at least a portion of the aqueous liquid from the pores of the liquid-entrained porous solid material with the polar organic liquid and separating the displaced aqueous liquid from the polar organic liquid. The method additionally includes removing the polar organic liquid from the pores of the liquid-entrained porous solid material to form a dry porous solid material.

### CROSS-REFERENCE TO RELATED APPLICATIONS

This application is a national phase entry under 35 U.S.C. § 371 of International Patent Application PCT/US2023/076652, filed Oct. 12, 2023, designating the United States of America and published as International Patent Publication WO 2024/081760 A1 on Apr. 18, 2024, which claims the benefit under Article 8 of the Patent Cooperation Treaty of U.S. patent application Ser. No. 63/379,268, filed Oct. 12, 2022.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

The disclosure, in various embodiments, relates generally to the field of removing aqueous liquids from solid materials. More specifically, the disclosure relates to systems and methods for displacing aqueous liquids (e.g., water) from porous solid materials with a polar organic liquid (e.g., water-soluble organic solvent and/or partially water-soluble organic solvent).

### BACKGROUND

The industrial drying of solids is conventionally accomplished through vaporization of contained liquid via heating. Substantial drying uses sufficient and often significant heat of vaporization, air recirculation for vapor removal, and diffusion of liquid and vapor to the solid surface. Initially, drying of wet solids proceeds at a constant rate. Once water content has been reduced to a defined amount, i.e., a critical moisture content, the speed of drying decelerates through a falling-rate period. Drying in the falling-rate period is slowed by an increasing a distance from an outside surface of the solid to a drying front. A second falling-rate period, during which evaporation takes place from within the solid, occurs when the drying rate is no longer sensitive to external conditions.

The two primary classes of industrial drying equipment are adiabatic dryers and non-adiabatic dryers. In adiabatic drying, wet solids are exposed to heated gas through various approaches, including cross circulation, through-circulation, solid flow through a slow-moving gas stream (e.g., rotary drying), in a fluidized bed, or in a high-velocity gas stream (e.g., flash drying). In non-adiabatic drying, heat is applied to the wet solids through a medium other than air, such as a metal heat conductor. While contact dryers feature higher thermal efficiency than adiabatic dryers, they are less common in industrial applications.

Just as the process of wetting solids generally induces volumetric swelling, the process of drying solids generally brings about volumetric contraction or shrinkage. The shrinkage accompanying drying may impact the quality of the dried solids. Macroscopic and microscopic models have been proposed for contractive cracking. In the macroscopic model, uniform stresses occur during drying, resulting in cracking dispersed throughout the solid material. In the microscopic model, heterogeneity and asymmetry of pores result in faster evaporation in larger pores, inducing relaxation and disproportionately large stresses on smaller pores. Solvent displacement supercritical drying has been investigated to reduce the amount of contractive cracking. However, the process is limited by high operational pressures and/or temperatures.

Water-miscible organic solvents such as dimethyl ether (DME) have been explored for drying applications. DME is used in conventional solvent drying applications, primarily due to its gaseous state at a temperature of about 25 degrees Celsius (C) and a pressure of about 101 kilopascals (kPa) absolute, and its capability to be condensed to a liquid at moderate pressures of about 507 kPa absolute to about 608 kPa absolute, as well as the moderate solubility of water in condensed liquid DME. For example, when sufficient condensed liquid DME is added to a system containing water, the water dissolves into the DME-rich liquid, where it can be transferred to a separate chamber. Upon transfer, pressure is reduced to volatilize the DME into a vapor, leaving behind the extracted water. Studies have indicated that from about 13 grams to about 25 grams of liquefied DME are used for the extraction of about 1 gram of water from “wet” porous solid materials. This method has also been utilized for the extraction of additional DME-soluble constituents of solid materials.

Conventional industrial techniques for the drying of solids at large scale are energy-intensive and induce mechanical damage to solid products. Although alternative techniques, which rely on dissolution of water into solvents, may use less energy than thermal drying techniques, they employ significant solvent to water ratios (e.g., solvent to water ratios of from about 13:1 to about 25:1).

### BRIEF SUMMARY

A method for removing an aqueous liquid from a liquid-entrained porous solid material includes contacting the liquid-entrained porous solid material with a polar organic liquid, the liquid-entrained porous solid material containing the aqueous liquid in pores thereof. The method also includes displacing at least a portion of the aqueous liquid from the pores of the liquid-entrained porous solid material with the polar organic liquid and separating the displaced aqueous liquid from the polar organic liquid. The method additionally includes removing the polar organic liquid from the pores of the liquid-entrained porous solid material to form a dry porous solid material.

Another method for removing an aqueous liquid from a liquid-entrained porous solid material includes contacting the liquid-entrained porous solid material comprising the aqueous liquid in pores thereof with dimethyl ether. The method also includes replacing at least a portion of the aqueous liquid in the pores of the liquid-entrained porous solid material with the dimethyl ether and separating the aqueous liquid from the dimethyl ether. The method further includes volatilizing the dimethyl ether in the pores of the liquid-entrained porous solid material to form a dry porous solid material and recovering the dimethyl ether.

A system for removing an aqueous liquid from a liquid-entrained porous solid material having a contactor configured and dimensioned to receive a porous solid material therein, the porous solid material comprising an aqueous liquid in pores thereof. A polar organic liquid source is disposed in fluid communication with the contactor, and a polar organic liquid transfer device is configured to transfer an amount of the polar organic liquid from the polar organic liquid source to the contactor under pressure. The system includes an outlet disposed in fluid communication with the contactor and configured to allow an amount of aqueous liquid displaced from the pores to be discharged therefrom. A heat source is disposed in communication with the contactor and configured to elevate a temperature of the porous solid material to vaporize the polar organic liquid remaining therein, and a vapor outlet is disposed in fluid communication with the contactor and configured to allow the vaporized polar organic liquid to be discharged therefrom.

### BRIEF DESCRIPTION OF THE DRAWINGS

FIG. 1 is a simplified schematic diagram, and an enlarged inset therefrom, of a liquid-entrained porous solid material where pores of the porous solid material are substantially filled with an aqueous liquid, in accordance with embodiments of the disclosure.

FIG. 2 is a simplified schematic diagram, and an enlarged inset therefrom, of the liquid-entrained porous solid material where a polar organic liquid has partially displaced the aqueous liquid from the pores, in accordance with embodiments of the disclosure.

FIG. 3 is a simplified schematic diagram, and an enlarged inset therefrom, of the liquid-entrained porous solid material where the pores are substantially filled with a polar organic liquid, in accordance with embodiments of the disclosure.

FIG. 4 is a simplified schematic diagram, and an enlarged inset therefrom, of a porous solid material where the pores are substantially free of the aqueous liquid and the polar organic liquid, in accordance with embodiments of the disclosure.

FIG. 5 is a simplified schematic diagram of a system for removing an aqueous liquid from a porous solid material via solvent displacement, in accordance with embodiments of the disclosure.

FIG. 6 is a simplified schematic diagram of the system of FIG. 5 in operation, in accordance with embodiments of the disclosure.

FIG. 7 is a block diagram of a method for removing an aqueous liquid from a porous solid material via solvent displacement, in accordance with embodiments of the disclosure.

### DETAILED DESCRIPTION

In the following detailed description, reference is made to the accompanying drawings, which form a part hereof, and in which are shown, by way of illustration, exemplary embodiments in which the disclosure may be practiced. These embodiments are described in sufficient detail to enable a person of ordinary skill in the art to practice the disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

It will be readily understood that the components of the embodiments as generally described herein and illustrated in the drawings may be arranged and designed in a wide variety of different configurations. Thus, the following description of various embodiments is not intended to limit the scope of the disclosure but is merely representative of the various embodiments. While the various aspects of the embodiments may be presented in drawings, the drawings are not necessarily drawn to scale unless specifically indicated.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of any embodiments or this disclosure to the specified components, acts, features, functions, or the like.

Thus, specific implementations shown and described are only examples and should not be construed as the only way to implement the disclosure unless specified otherwise herein. Elements, apparatuses, and methods may be shown in schematic or block diagram form in order not to obscure the disclosure in unnecessary detail. Conversely, specific implementations shown and described are exemplary only and should not be construed as the only way to implement the disclosure unless specified otherwise herein. It will be readily apparent to one of ordinary skill in the art that the disclosure may be practiced by numerous other solutions. For the most part, details concerning flow rates and other process parameters have been omitted where such details are not necessary to obtain a complete understanding of the disclosure and are within the abilities of persons of ordinary skill in the relevant art.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of embodiments of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings and does not connote or depend on any specific preference or order, except where the context clearly indicates otherwise. For example, these terms may refer to an orientation of elements when utilized in a conventional manner. Furthermore, these terms may refer to an orientation of elements as illustrated in the drawings.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or at least 99.9% met.

The systems and methods according to embodiments of the disclosure advance solvent-driven water extraction processes through physical displacement of aqueous liquids (e.g., aqueous solutions) from pores and/or interstitial spaces within a porous solid material (e.g., a granular solid material). The aqueous liquid in the pores of the porous solid material may be displaced by a solvent or solvents. The systems and methods according to embodiments of the disclosure approach or exceed a mass ratio of solvent: water displaced of about 0.5:1.0 (i.e., a greater mass of water may be displaced for each unit mass of solvent employed) to about 1.0:0.5 (i.e., a lesser mass of water may be displaced for each unit mass of solvent employed), thus providing energy- and reagent-efficient dewatering of a liquid-entrained porous solid material (e.g., a wet porous solid material).

Solvent-driven water displacement, in accordance with embodiments of the disclosure, utilizes a solvent volume of less than or equal to about the volume of aqueous liquids initially contained in and physically displaced from the pores of the liquid-entrained porous solid material (e.g., a wet porous solid material), thus serving as an energy-and reagent-efficient dewatering process for the liquid-entrained porous solid materials. The liquid-entrained porous solid material may originate from complex biological and chemical treatment pathways, mineral production, etc. Liquid-entrained porous solid materials (e.g., a wet porous solid material) that may be dewatered by the disclosed embodiments include, but are in no manner limited to: biomass solids; food solids for human consumption; feedstock solids for animal husbandry; and slurries and wet solids resulting from mineral extraction. By way of example only, the liquid-entrained porous solid material may be a slurry concentrate obtained from a mining process.

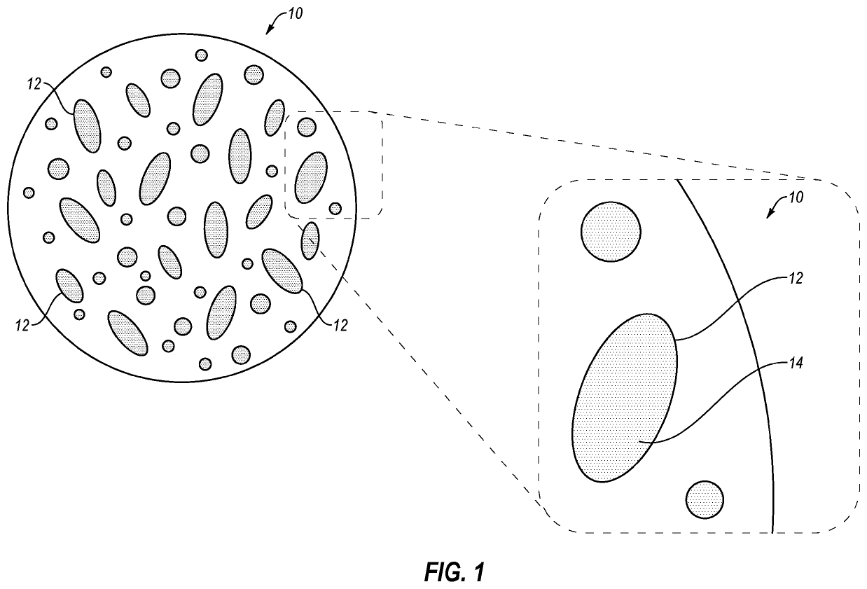

FIG. 1 is a simplified schematic diagram of a liquid-entrained porous solid material 10 where pores 12 are at least partially filled with an aqueous liquid 14, in accordance with embodiments of the disclosure. The pores 12 may also be referred to herein as liquid-entrained pores 12 and the liquid-entrained porous solid material 10 may also be referred to herein as a wet porous solid material 10. The pores 12 may include pore structure as well as water (e.g., interstitial water, chemically bound water) within the liquid-entrained porous solid material 10. The liquid-entrained porous solid material 10, in accordance with embodiments of the disclosure, may include, but is in no manner limited to, reticulated masses, primarily closed cell masses, earthen masses with porosities that allow contact of aqueous moisture content within the porosities with water-soluble organic liquids, granular materials, and combinations thereof. The pores 12 of a liquid-entrained porous solid material 10, in accordance with embodiments of the present disclosure, may have a combined volume in a range of from about 5% to about 85% of the total volume of the liquid-entrained porous solid material 10, inclusive of the volume of the pores 12. In some embodiments, the pores 12 may be uniform in configuration and/or volume. In other embodiments, the pores 12 may have non-uniform configurations and/or volumes.

FIG. 1 includes an enlarged inset of a portion thereof that illustrates an aqueous liquid 14 (e.g., an aqueous moisture content) substantially filling the pores 12 (e.g., interstitial spaces) of the liquid-entrained porous solid material 10. In other words, the aqueous liquid 14 is at least initially present within the pores 12 of the porous solid material 10, resulting in the liquid-entrained pores 12 of the liquid-entrained porous solid material 10.

FIG. 1 illustrates the liquid-entrained pores 12 of the liquid-entrained porous solid material 10 being substantially filled (e.g., substantially completely filled) with the aqueous liquid 14. However, in some embodiments, the liquid-entrained pores 12 of the liquid-entrained porous solid material 10 may be partially filled with the aqueous liquid 14. In other embodiments, the liquid-entrained pores 12 of the liquid-entrained porous solid material 10 are substantially completely filled with the aqueous liquid 14. The liquid-entrained porous solid material 10, in accordance with embodiments of the disclosure, may contain the aqueous liquid 14 in amounts from about 10% to about 90% by weight of the combined weight of the liquid-entrained porous solid material 10 and the aqueous liquid 14, or from about 20% to about 80% by weight, or from about 30% to about 70% by weight, or from about 40% to about 60% by weight (e.g., about 50% by weight of the combined weight of the liquid-entrained porous solid material 10 and the aqueous liquid 14).

The aqueous liquid 14 within the pores 12 includes water and, optionally, one or more additives or impurities. The additives, if present, in the aqueous liquid 14 may include, but are not limited to, one or more salts, one or more acids, one or more bases, one or more surfactants, or combinations thereof. The impurities in the aqueous liquid 14 may be materials initially present in the porous solid material 10 and/or in the aqueous liquid 14 itself and may include, but are not limited to, metals, oils, resins, waxes, other organic molecules, other water-soluble materials, colloid suspended materials, salts, silica, ash, surfactants, or combinations thereof.

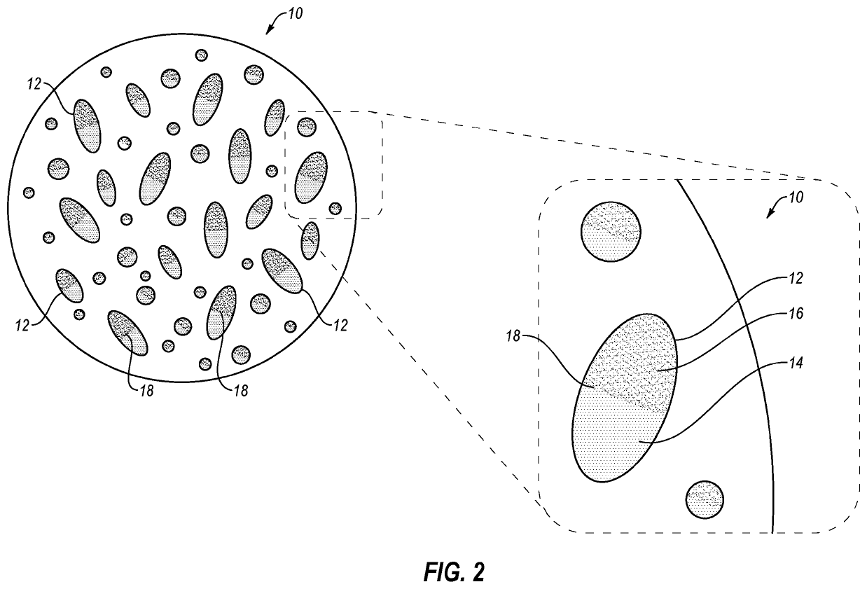

FIG. 2 is a simplified schematic diagram of the liquid-entrained porous solid material 10 where a polar organic liquid 16 (e.g., water-soluble organic solvent, partially water-soluble organic solvent) has at least partially, physically displaced the aqueous liquid 14 from the liquid-entrained pores 12 (e.g., partially, physically displaced the aqueous liquid 14 from the liquid-entrained pores 12 of the liquid-entrained porous solid material 10 of FIG. 1), in accordance with embodiments of the disclosure. Similar to FIG. 1, FIG. 2 includes an enlarged inset of a portion thereof, where the enlarged inset of FIG. 2 illustrates the aqueous liquid 14 partially filling the liquid-entrained pores 12 (e.g., interstitial spaces) of the liquid-entrained porous solid material 10, and the remainder of the liquid-entrained pores 12 being filled with the polar organic liquid 16. Specifically, the enlarged insert of FIG. 2 illustrates the introduction of the polar organic liquid 16 to the liquid-entrained porous solid material 10, which, over time, begins to physically displace the aqueous liquid 14 from the liquid-entrained pores 12.

In some embodiments, an amount of the aqueous liquid 14 contained in the liquid-entrained porous solid material 10 has a first volume and an amount of the polar organic liquid 16 has a second volume, where the first volume is greater than or equal to the second volume.

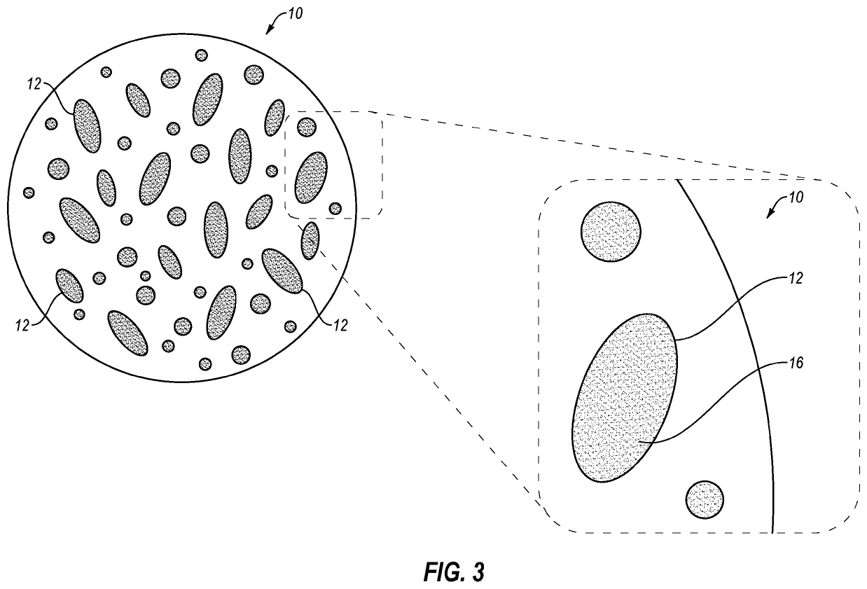

FIG. 3 is a simplified schematic diagram, and an enlarged inset therefrom, of the liquid-entrained porous solid material 10 where the liquid-entrained pores 12 are substantially filled with the polar organic liquid 16 (e.g., water-soluble organic solvent, partially water-soluble organic solvent), in accordance with embodiments of the disclosure. More particularly, the enlarged inset of FIG. 3 is illustrative of the liquid-entrained porous solid material 10 after the polar organic liquid 16 has substantially physically displaced (e.g., substantially completely displaced) the aqueous liquid 14 originally present therein (FIG. 1). By maintaining the polar organic liquid 16 in contact with the liquid-entrained porous solid material 10, the aqueous liquid 14 is physically displaced from the liquid-entrained porous solid material 10 via polar molecular interactions with the polar organic liquid 16. In some embodiments, the polar organic liquid 16 also substantially physically displaces (e.g., substantially completely displaces) one or more of the impurities present in the aqueous liquid 14 (FIG. 1).

The polar organic liquid 16 may include one or more organic solvents (e.g., dimethyl ether, propane, 1-butanol). The polar organic liquid 16 may optionally include one or more additives including, but in no manner limited to, water, salts, acids, bases, surfactants, or combinations thereof. The polar organic liquid 16 may be at least partially soluble in water or may be substantially soluble in water. In some embodiments, the polar organic liquid 16 is dimethyl ether (DME).

The polar organic liquid 16 may displace from about 30% to about 99% by volume of the aqueous liquid 14 from the liquid-entrained pores 12 of the liquid-entrained porous solid material 10. In some embodiments, the polar organic liquid 16 may displace from about 40% to about 80% by volume of the aqueous liquid 14 from the liquid-entrained pores 12 of the liquid-entrained porous solid material 10. In other embodiments, the polar organic liquid 16 may displace from about 50% to about 70% by volume of the aqueous liquid 14 from the liquid-entrained pores 12 of the liquid-entrained porous solid material 10.

The physical displacement of the aqueous liquid 14 from the liquid-entrained porous solid material 10 using the polar organic liquid 16 may be facilitated by the relatively low surface tension of the polar organic liquid 16. Water has a relatively high surface tension of about 72 millinewtons per meter (mN m⁻¹), whereas organic solvents have considerably lower surface tensions (e.g., acetone has a surface tension of about 24 mN m⁻¹). Dimethyl ether has a surface tension of about 12 mN m⁻¹. A water-DME solvent system may have a specific surface tension that is likely lower than that of either pure water or pure DME. Differences in density between the aqueous liquid 14 and the polar organic liquid 16 may also facilitate the physical displacement of the aqueous liquid 14. In some embodiments, for example, when dewatering high-water content liquid-entrained porous solid materials 10 (e.g., having greater than about 50% by weight aqueous liquid 14), the high-water content liquid-entrained porous solid materials 10 may be pretreated with amounts of dilute acids and/or dilute bases to further facilitate the physical displacement of the aqueous liquid 14 from the liquid-entrained porous solid material 10.

Furthermore, the composition of the polar organic liquid 16 may be adjusted to address different ionic-strengths of the aqueous liquid 14 to be displaced from the liquid-entrained porous solid material 10. For example, a high ionic strength aqueous liquid 14 may be more susceptible to solvent-driven pore displacement, thus minimizing (e.g., preventing) the polar organic liquid 16 from readily dissolving into the aqueous liquid 14, and vice versa, minimizing the amount of the polar organic liquid 16 used for the dewatering process. By limiting the amount of the polar organic liquid 16 used (e.g., limiting the amount of DME used), in accordance with embodiments of the disclosure, the physical displacement of the aqueous liquid 14 may be completed with minimal dissolution of the aqueous phase (e.g., the aqueous liquid 14) into the organic phase (e.g., the polar organic liquid 16), significantly increasing (e.g., maximizing) the efficiency of dewatering the liquid-entrained porous solid material 10.

Additional efficiencies may be realized by incorporating one or more optional additives in the aqueous liquid 14 and/or the polar organic liquid 16, where the additives promote cohesion in the aqueous phase and/or the organic phase, as well as to minimize (e.g., prevent) dissolution of the aqueous liquid 14 into the polar organic liquid 16, and to minimize (e.g., prevent) dissolution of the polar organic liquid 16 into the aqueous liquid 14. As before, the additives may include water, one or more salts, one or more acids, one or more bases, one or more surfactants, one or more solvents other than DME, or combinations thereof. Additive containing DME may be recovered through a sequential treatment with substantially pure grade DME, whereby residual DME and contained additives are also displaced from the liquid-entrained porous solid materials 10. The original additive containing DME mixture and pure DME may then be restored through an established protocol for recovery and compression of pure DME.

Once the aqueous liquid 14 has been substantially physically displaced (e.g., completely displaced) from the liquid-entrained pores 12 of the liquid-entrained porous solid material 10 by the polar organic liquid 16, the temperature proximate the liquid-entrained porous solid material 10 may be slightly increased (e.g., to about 25 °C, to about 30 °C) and/or the pressure proximate the liquid-entrained porous solid material 10 may be reduced (e.g., from about 10 kPa absolute to about 456 kPa absolute), causing the polar organic liquid 16 to volatilize and migrate from the liquid-entrained porous solid material 10.

In some embodiments, the volatilized polar organic liquid 16 may be recovered and recycled through the liquid-entrained porous solid material 10 (e.g., heap leaching techniques) to displace aqueous liquid 14 from the liquid-entrained pores 12 of the liquid-entrained porous solid material 10 that may remain therein after processing.

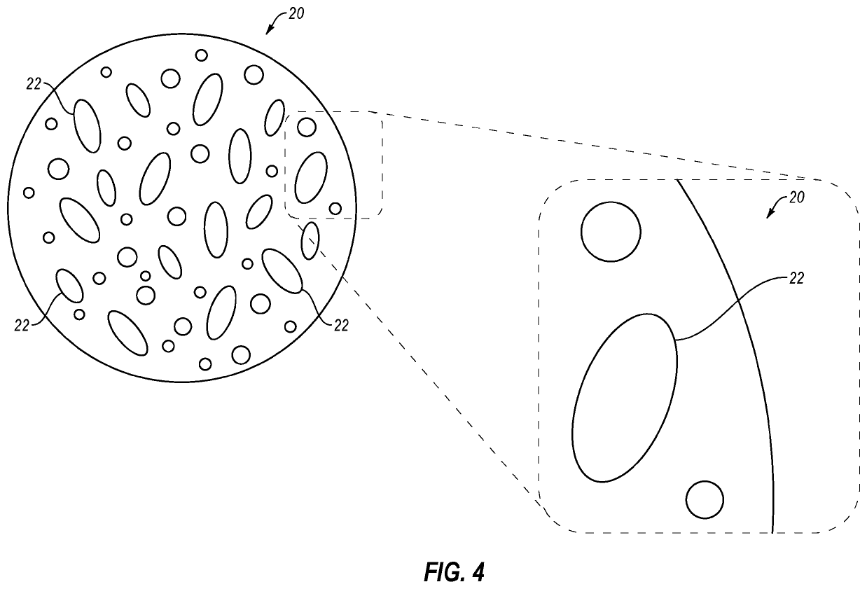

The removal of the polar organic liquid 16 forms a dry porous solid material 20. FIG. 4 is a simplified schematic diagram, and an enlarged inset therefrom, of the dry porous solid material 20 having a number of pores 22 (e.g., interstitial spaces) that lack at least a portion of the aqueous liquid 14 and the polar organic liquid 16. The pores 22 may also be referred to herein as dry pores 22. The dry pores 22 may be free of the aqueous liquid 14 and free of the polar organic liquid 16, in accordance with embodiments of the disclosure, such as being substantially free of the aqueous liquid 14 and substantially free of the polar organic liquid 16.

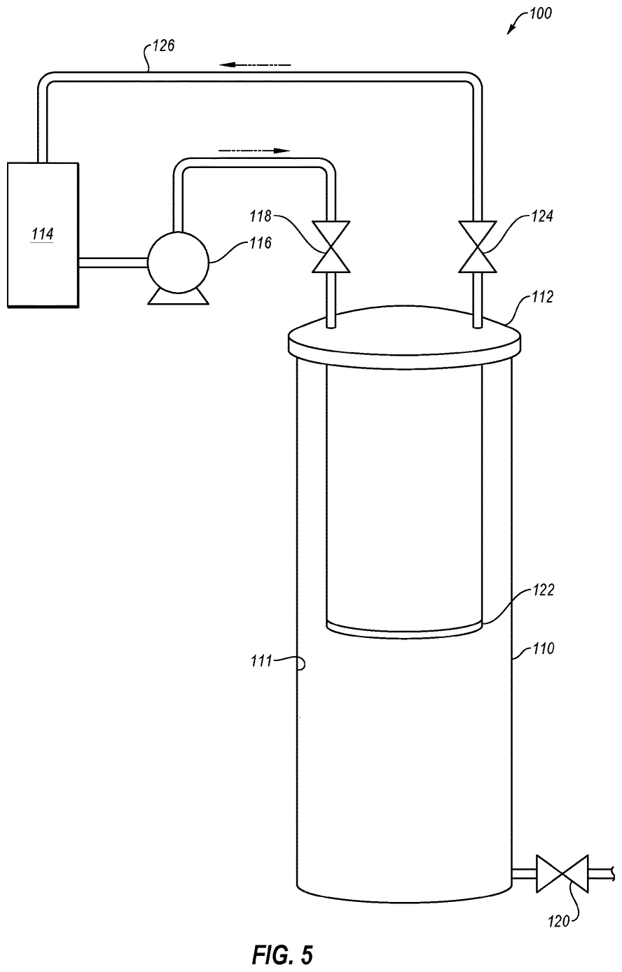

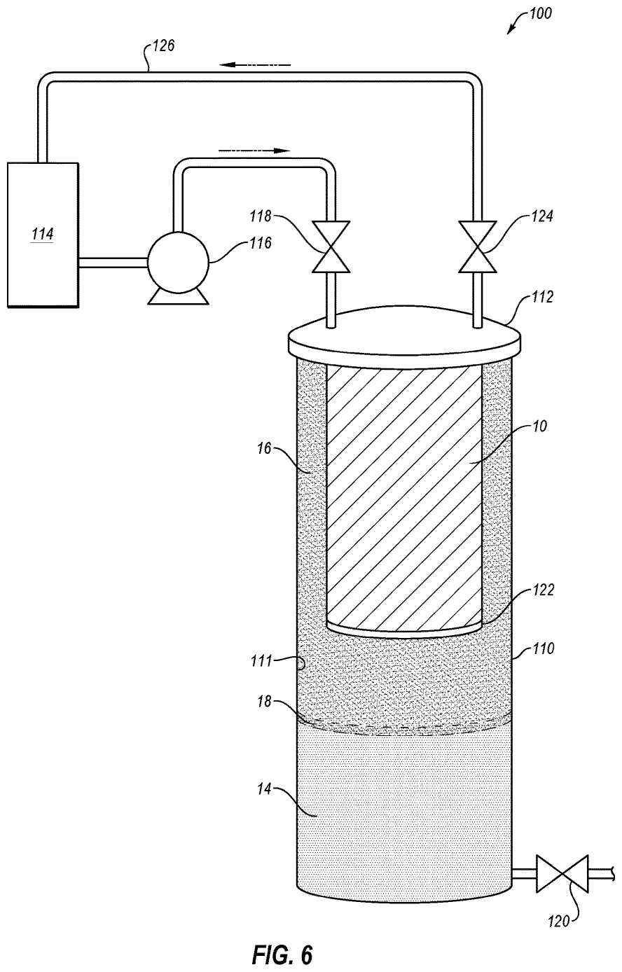

FIGS. 5 and 6 are simplified schematic diagrams of a system 100 for removing an aqueous liquid from a porous solid material via solvent displacement, in accordance with embodiments of the disclosure. The system 100 for removing an aqueous liquid (e.g., the aqueous liquid 14) from the porous solid material (e.g., the liquid-entrained porous solid material 10) via solvent displacement (e.g., via physical displacement) with a polar organic liquid (e.g., the polar organic liquid 16) includes a contactor 110. The contactor 110 may include any suitable liquid-solid processing equipment including, but not limited to, a rotary screw compressor configured to carry the liquid-entrained porous solid material 10 through a liquid solvent environment (e.g., through the polar organic liquid 16). The contactor 110 may include chambers (not shown) at an inlet and an outlet to minimize solvent losses therefrom. In some embodiments, the contactor 110 is constructed of a thermally insulative material to allow a temperature therein to be adjusted (e.g., controlled) during a dewatering process. In some other embodiments, the contactor 110 is constructed of a pressure resistant material able to withstand minimal to moderate operating pressures (e.g., about 203 kPa absolute, about 405 kPa absolute, about 608 kPa absolute), as well as minimal to moderate vacuums (e.g., about 5 kPa vacuum, about 51 kPa vacuum, about 101 kPa vacuum).

The contactor 110, in accordance with embodiments of the disclosure, includes a processing volume 111 that may be sized and configured to accommodate a volume of the liquid-entrained porous solid material 10 to be dewatered. The contactor 110 also includes a closure 112 (e.g., lid) that substantially seals the processing volume 111 of the contactor from the surrounding ambient conditions (e.g., temperature, pressure, humidity, etc.), such that the processing environment within the processing volume 111 may be adjusted (e.g., controlled) to facilitate the dewatering process. The closure 112 may also be constructed of thermally insulative material configured to withstand minimal to moderate operating pressures or vacuums, similar to the contactor 110.

With continued reference to FIGS. 5 and 6, the contactor 110 may be charged with an amount of liquid-entrained porous solid material 10. An amount of a polar organic liquid 16 may be added to the contactor 110 and brought into contact with the liquid-entrained porous solid materials 10. In some embodiments, an initial amount of a polar organic liquid 16 may be equal to about 50% of the estimated (e.g., measured, calculated) mass of aqueous liquid 14 contained in the liquid-entrained porous solid materials 10. In other embodiments, a second amount of a polar organic liquid 16 may also be equal to about 50% of the estimated mass of aqueous liquid 14 contained in the liquid-entrained porous solid materials 10 and may be added to the liquid-entrained porous solid materials 10 in the contactor 110 after the initial amount has substantially percolated through the liquid-entrained porous solid materials 10 in the contactor 110.

A polar organic liquid source 114 (e.g., a liquified DME storage tank) may be provided and disposed in fluid communication with the contactor 110. In some embodiments, a polar organic liquid transfer device 116 (e.g., a pump) is configured to transfer an amount of the polar organic liquid 16 (e.g., DME) from the polar organic liquid source 114 to the contactor 110 at minimal to moderate operating pressures (e.g., about 203 kPa absolute, about 405 kPa absolute, about 608 kPa absolute), slightly pressurizing the contactor 110 to a minimal to moderate operating pressure. A polar organic liquid inlet 118 (e.g., inlet valve) may be provided to permit the transfer of the polar organic liquid 16 into the contactor 110. As shown in FIGS. 5 and 6, in some embodiments, a polar organic liquid inlet 118 is disposed in communication with the processing volume 111 of the contactor 110 through the closure 112 thereof.

During use and operation, an amount of aqueous liquid 14 is physically displaced from the liquid-entrained porous solid materials 10 and migrates to lower portions of the contactor 110. A liquid outlet 120 (e.g., outlet valve) is provided to allow amounts of the aqueous liquid 14, which have been displaced from the liquid-entrained porous solid materials 10, to be at least periodically discharged from the contactor 110 during a dewatering process. For example, the aqueous liquid 14 may be substantially continuously recovered from the contactor 110. An aqueous-organic interface 18 may form between the aqueous liquid 14 and the polar organic liquid 16 present in the contactor 110, as shown in FIG. 6. More particularly, the aqueous liquid 14 and the polar organic liquid 16 may phase separate from one another based on density differences, such that the denser, aqueous liquid 14 sinks to the lower portions of the contactor 110 and the lighter, polar organic liquid 16 rises to upper portions of the contactor 110, i.e., above the aqueous liquid 14 in the contactor 110. In some embodiments, the aqueous liquid 14 may be removed and recovered from the contactor 110 by conventional liquid-liquid separation techniques for reuse or disposal.

After processing in the contactor 110, the liquid-entrained porous solid materials 10 may be substantially free of the aqueous liquid 14, which has been physically displaced (e.g., substantially replaced) by the polar organic liquid 16. As shown in FIG. 6, after processing, the polar organic liquid 16 (e.g., organic phase) in the contactor 110 may be substantially free of the aqueous liquid 14 (e.g., aqueous phase), and the aqueous liquid 14 in the contactor 110 may be substantially free of the polar organic liquid 16.

After the aqueous liquid 14 has been substantially physically displaced from the liquid-entrained porous solid materials 10, the liquid-entrained porous solid materials 10 may be further processed to remove the polar organic liquid 16 in the liquid-entrained pores 12 thereof (FIGS. 1-3) by volatilizing (e.g., flashing) the polar organic liquid 16. As one example, the temperature and/or pressure conditions within the contactor 110 may be adjusted to conditions under which the polar organic liquid 16 will volatilize. In some embodiments, such as where the polar organic liquid 16 is DME, the temperature conditions within the contactor 110 may be adjusted to slightly above about 25 °C (e.g., to about 30 °C) at about 101 kPa absolute. In other embodiments, where the polar organic liquid 16 is DME, the pressure conditions within the contactor 110 may be adjusted to slightly below about 101 kPa absolute (e.g., to about 5 kPa vacuum, to about 51 kPa vacuum, to about 101 kPa vacuum) at about 25 °C.

The contactor 110, in some embodiments, may be in communication with a heat source 122 to provide the thermal energy to increase the temperature within the contactor 110, if needed, to volatilize the polar organic liquid 16. The heat source 122 may be an adiabatic dryer (e.g., rotary dryer, flash dryer) or a non-adiabatic dryer (e.g., resistive heating element).

In some embodiments, a vapor outlet 124 (e.g., discharge valve) and/or a polar organic liquid recovery line 126 are provided to return the volatilized polar organic liquid 16 to the polar organic liquid source 114 for recovery, reprocessing, and/or reuse in subsequent dewatering processes.

The dry porous solid materials 20 (FIG. 4) obtained from embodiments of the system 100, in accordance with the disclosure, may be used for a variety of purposes. As one example, the reduction in aqueous liquid 14 present in an amount of dry porous solid materials 20, relative to an initial amount of liquid-entrained porous solid materials 10, translates into a reduction in weight, which may be substantial, reducing the costs of handling and/or transport of the dry porous solid material 20 for further processing, reuse or disposal. Additionally, wet solid materials may present hazards during transport, particularly via ships and barges where liquification and shifting may occur causing vessels to list and/or capsize. As a result, the water content in solid materials transported in such vessels is highly regulated, and the reduction in aqueous liquid 14 present in dry porous solid materials 20 minimizes, if not eliminates, these potential hazards. As another example, such as where dry porous solid materials 20 are intended for use in smelting operations, the reduction in aqueous liquid 14 from the initial liquid-entrained porous solid materials 10 results in a reduction in the energy costs of the smelting operation, as well as a reduction in exhaust gasses, including potentially environmentally harmful exhaust gasses, produced during the smelting operation.

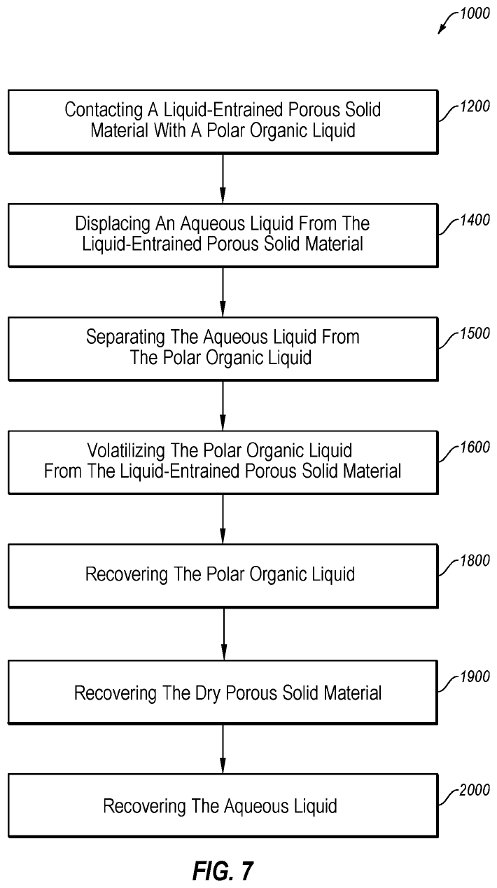

FIG. 7 presents a block diagram of a method 1000 for removing an aqueous liquid from a porous solid material via solvent displacement, in accordance with embodiments of the disclosure. The method 1000 includes contacting a liquid-entrained porous solid material with a polar organic liquid 1200. The liquid-entrained porous solid material may include an aqueous liquid in pores thereof. In at least some embodiments, the polar organic liquid may be dimethyl ether (DME). In a further act, the method 1000 includes displacing (e.g., physically displacing) the aqueous liquid from the liquid-entrained porous solid material 1400. In some embodiments, the method 1000 includes displacing the aqueous liquid from at least some of the liquid-entrained pores of the liquid-entrained porous solid material 1400 with the polar organic liquid. In other embodiments, the method 1000 includes displacing (e.g., completely displacing) an aqueous liquid from substantially all of the liquid-entrained pores of the liquid-entrained porous solid material 1400 with the polar organic liquid.

With continued reference to FIG. 7, the method 1000 also includes separating the aqueous liquid displaced from the liquid-entrained porous solid material from the polar organic liquid 1500, such as by gravimetric liquid-liquid separation. In other embodiments, separating the aqueous liquid from the polar organic liquid 1500 is accomplished under acceleration, which may be less than or greater than the acceleration of gravity at sea level on earth; i.e., less than or greater than about 9.8 meters per second squared (m/s²), such as, by way of example only, greater than or equal to about 0.98 m/s². A solid-liquid contactor (e.g., contactor 110) may be employed to implement the foregoing acts.

With continued reference to FIG. 7, after displacing the aqueous liquid from the liquid-entrained porous solid material 1400, the method 1000 includes volatilizing the polar organic liquid 1600. Specifically, in some embodiments, the method 1000 includes volatilizing the polar organic liquid present in the liquid-entrained porous solid material after substantial physical displacement of the aqueous liquid originally contained therein, forming a dry porous solid material, as disclosed and described hereinabove. As before, a solid-liquid contactor (e.g., contactor 110) may be employed to affect the foregoing acts.

In at least some embodiments, the method 1000 for removing an aqueous liquid from a porous solid material via solvent displacement includes the further act of recovering the polar organic liquid 1800. For example, a polar organic liquid (e.g., DME) may be recovered and returned to a polar organic liquid supply for reprocessing and/or reuse in subsequent dewatering processes. Once again, a solid-liquid contactor (e.g., contactor 110) may be employed to accomplish the foregoing act.

Looking again at FIG. 7, the method 1000 for removing an aqueous liquid from a porous solid material via solvent displacement includes the further act of recovering the dry porous solid material 1900. In some embodiments, the recovered dry porous solid material may be used in a further process. In other embodiments, the recovered dry porous material is prepared for transport for reuse or disposal.

As shown in FIG. 7, in some embodiments, the method 1000 for removing an aqueous liquid from a porous solid material via solvent displacement also includes the further act of recovering the aqueous liquid displaced from the liquid-entrained solid material 2000. In some embodiments, the aqueous liquid may be removed and recovered from a solid-liquid contactor (e.g., contactor 110) by conventional liquid-liquid separation techniques for reuse or disposal.

Systems and methods, in accordance with embodiments of the disclosure, may further include an aqueous liquid 14 having a first volume and a polar organic liquid 16 having a second volume, wherein the first volume is greater than or equal to the second volume.

Systems and methods, in accordance with embodiments of the disclosure, may also include a polar organic liquid 16 being dimethyl ether (DME).

Systems and methods, in accordance with embodiments of the disclosure, may additionally include introducing a polar organic liquid 16 to a liquid-entrained porous solid material 10 under minimal to moderate pressure conditions (e.g., about 203 kPa absolute, about 405 kPa absolute, about 608 kPa absolute) to allow use of a polar organic liquid 16 that may otherwise be a gas or vapor at or near ambient conditions (e.g., about 101 kPa absolute at about 25 °C).

Systems and methods, in accordance with embodiments of the disclosure, may also include an aqueous liquid 14 containing at least one of water-soluble materials, colloid suspended materials, salts, silica, ash, surfactants, and combinations thereof, and wherein physically displacing the aqueous liquid 14 from a liquid-entrained porous solid material 10 includes displacing at least one of water-soluble materials, colloid suspended materials, salts, silica, ash, surfactants, and combinations thereof from the liquid-entrained porous solid material 10.

Systems and methods, in accordance with embodiments of the disclosure, may further include a polar organic liquid 16 having at least one additive such as water, salts, acids, bases, surfactants, additional water-soluble organic compositions, or a combination thereof.

Systems and methods, in accordance with embodiments of the disclosure, may be implemented with any of a number of liquid-entrained porous solid materials 10 including reticulated masses, primarily closed cell masses, earthen masses with porosities dimensioned and configured to allow contact of aqueous moisture content within the porosities with water-soluble organic liquids, granular materials, and combinations thereof.

Systems and methods, in accordance with embodiments of the disclosure, may further include a polar organic liquid 16 that is recycled through a liquid-entrained porous solid material 10 (e.g., heap leaching techniques).

Systems and methods, in accordance with embodiments of the disclosure, may additionally include separating an aqueous liquid 14 from a polar organic liquid 16 under acceleration, which may be less than or greater than the acceleration of gravity at sea level on earth, i.e., less than or greater than about 9.8 meters per second squared (m/s²), such as, by way of example only, greater than or equal to about 0.98 m/s².

Systems and methods, in accordance with embodiments of the disclosure, may also include dewatering high-water content liquid-entrained porous solid materials 10 (e.g., greater than about 50% by weight aqueous liquid 14) that have been pretreated with dilute acids and/or dilute bases.

Conventional industrial techniques for the drying of solids at scale are energy-intensive and induce mechanical damage to solid products. Alternative techniques that rely on dissolution of water into solvents use large volumes of solvent and may not be suitable for wet solid materials containing complex aqueous solutions. The systems (e.g., system 100) and methods (e.g., method 1000) for removing an aqueous liquid 14 from a liquid-entrained porous solid material 10 according to embodiments of the disclosure utilize minimal mass ratios of a polar organic liquid 16 to displace an equal or greater mass of aqueous liquid 14 (e.g., solvent:water displaced of about 0.5:1.0 to about 1.0:0.5) entrained within pores and interstitial spaces of a liquid-entrained porous solid material 10, thus serving as an energy-and reagent-efficient dewatering process for liquid-entrained porous solid materials (e.g., a wet porous solid materials) generated from any of a number of processes.

Among the useful aspects of the systems (e.g., system 100) and methods (e.g., method 1000), in accordance with embodiments of the disclosure, is the reduction of heat energy used for initial dewatering of wet solid materials. Another useful aspect of the systems (e.g., system 100) and methods (e.g., method 1000), in accordance with embodiments of the disclosure, is the reduction of solvent used for initial dewatering of wet solid materials compared to other solvent-driven systems and methods. An additional useful aspect of the systems (e.g., system 100) and methods (e.g., method 1000), in accordance with embodiments of the disclosure, is the ability to ameliorate cracking damage that occurs in conventional solvent-driven dewatering systems and methods. Yet another useful aspect of the systems (e.g., system 100) and methods (e.g., method 1000), in accordance with embodiments of the disclosure, is that the foregoing achieved aspects allow for the removal of water-soluble and/or colloid suspended materials (e.g., ash and silica) with the aqueous phase (e.g., aqueous liquid 14).

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

1. A method for removing an aqueous liquid from a liquid-entrained porous solid material comprising:
contacting the liquid-entrained porous solid material with a polar organic liquid, the liquid-entrained porous solid material containing the aqueous liquid in pores thereof;
displacing at least a portion of the aqueous liquid from the pores of the liquid-entrained porous solid material with the polar organic liquid;
separating the displaced aqueous liquid from the polar organic liquid; and
removing the polar organic liquid from the pores of the liquid-entrained porous solid material to form a dry porous solid material.

2. The method of claim 1, wherein contacting the liquid-entrained porous solid material with the polar organic liquid comprises contacting the liquid-entrained porous solid material with an amount of the polar organic liquid that is less than or equal to an amount of the aqueous liquid in the pores of the liquid-entrained porous solid material.

3. The method of claim 1, wherein contacting the liquid-entrained porous solid material with the polar organic liquid comprises contacting the liquid-entrained porous solid material with a mass of the polar organic liquid that is less than or equal to a mass of the aqueous liquid in the pores of the liquid-entrained porous solid material.

4. The method of claim 1, wherein contacting the liquid-entrained porous solid material with the polar organic liquid comprises contacting the liquid-entrained porous solid material with the polar organic liquid under a pressure that is greater than ambient pressure.

5. The method of claim 1, wherein contacting the liquid-entrained porous solid material with the polar organic liquid comprises contacting the liquid-entrained porous solid material with an at least partially water-soluble polar organic liquid.

6. The method of claim 1, wherein contacting the liquid-entrained porous solid material with the polar organic liquid comprises contacting the liquid-entrained porous solid material with the polar organic liquid comprising at least one additive selected from the group consisting of water, salts, acids, bases, and surfactants.

7. The method of claim 1, wherein contacting the liquid-entrained porous solid material with the polar organic liquid comprises contacting the liquid-entrained porous solid material with dimethyl ether.

8. The method of claim 1, wherein displacing at least a portion of the aqueous liquid from the pores of the liquid-entrained porous solid material with the polar organic liquid comprises physically displacing the at least a portion of the aqueous liquid from at least some of the liquid-entrained pores of the liquid-entrained porous solid material with the polar organic liquid.

9. The method of claim 1, wherein displacing at least a portion of the aqueous liquid from the pores of the liquid-entrained porous solid material with the polar organic liquid comprises displacing the aqueous liquid from substantially all of the pores of the liquid-entrained porous solid material with the polar organic liquid.

10. The method of claim 1, wherein separating the displaced aqueous liquid from the polar organic liquid comprises separating the displaced aqueous liquid from the polar organic liquid via gravimetric liquid-liquid separation.

11. The method of claim 1, wherein separating the displaced aqueous liquid from the polar organic liquid comprises separating the displaced aqueous liquid from the polar organic liquid under an acceleration that is greater than or equal to about 0.98 meters per second squared.

12. The method of claim 1, wherein removing the polar organic liquid from the pores of the liquid-entrained porous solid material comprises volatilizing the polar organic liquid from at least some of the pores of the liquid-entrained porous solid material at a temperature of about 30 °C.

13. The method of claim 1, wherein removing the polar organic liquid from the pores of the liquid-entrained porous solid material comprises volatilizing the polar organic liquid from at least some of the pores of the liquid-entrained porous solid material at a pressure of from about 10 kilopascals absolute to about 456 kilopascals absolute.

14. A method for removing an aqueous liquid from a liquid-entrained porous solid material comprising:
contacting the liquid-entrained porous solid material comprising the aqueous liquid in pores thereof with dimethyl ether;
replacing at least a portion of the aqueous liquid in the pores of the liquid-entrained porous solid material with the dimethyl ether;
separating the aqueous liquid from the dimethyl ether;
volatilizing the dimethyl ether in the pores of the liquid-entrained porous solid material to form a dry porous solid material; and
recovering the dimethyl ether.

15. The method of claim 14, wherein contacting the liquid-entrained porous solid material comprising the aqueous liquid in the pores thereof with the dimethyl ether comprises contacting one or more of a reticulated mass, a primarily closed cell mass, an earthen mass, and a granular material with the dimethyl ether.

16. The method of claim 14, wherein the aqueous liquid comprises one or more water-soluble materials, colloid suspended materials, salts, silica, ash, and surfactants.

17. The method of claim 16, wherein replacing at least a portion of the aqueous liquid in the pores of the liquid-entrained porous solid material with the dimethyl ether comprises replacing the at least a portion of the aqueous liquid and the one or more water-soluble materials, colloid suspended materials, salts, silica, ash, and surfactants from the pores of the liquid-entrained porous solid material via physical displacement by the dimethyl ether.

18. The method of claim 14, wherein contacting the liquid-entrained porous solid material comprising the aqueous liquid in the pores thereof with the dimethyl ether comprises contacting the liquid-entrained porous solid material with a solution of the dimethyl ether comprising at least one additive selected from the group consisting of water, salts, acids, bases, and surfactants.

19. The method of claim 14, wherein replacing at least a portion of the aqueous liquid in the pores of the liquid-entrained porous solid material with the dimethyl ether comprises replacing from about 30% to about 99% by volume of the aqueous liquid in the pores of the liquid-entrained porous solid material with the dimethyl ether.

20. A system for removing an aqueous liquid from a liquid-entrained porous solid material comprising:
a contactor configured and dimensioned to receive a porous solid material therein, the porous solid material comprising an aqueous liquid in pores thereof;
a polar organic liquid source disposed in fluid communication with the contactor;
a polar organic liquid transfer device configured to transfer an amount of the polar organic liquid from the polar organic liquid source to the contactor under pressure;
an outlet disposed in fluid communication with the contactor and configured to allow an amount of aqueous liquid displaced from the pores of the porous solid material to be discharged therefrom;
a heat source disposed in communication with the contactor and configured to elevate a temperature of the porous solid material to vaporize the polar organic liquid remaining therein; and
a vapor outlet disposed in fluid communication with the contactor and configured to allow the vaporized polar organic liquid to be discharged therefrom.
